(19) United States
(12) Patent Application Publication
(10) Pub. No.: US 2009/0001024 A1
(43) Pub. Date: Jan. 1, 2009

(54) USING ASYMMETRICAL FLOW FOCUSING TO DETECT AND ENUMERATE MAGNETIC PARTICLES IN MICROSCALE FLOW SYSTEMS WITH EMBEDDED MAGNETIC-FIELD SENSORS

(76) Inventors: MARC D. PORTER, Ames, IA (US); NIKOLA PEKAS, Tempe, AZ (US)

Correspondence Address: MCKEE, VOORHEES & SEASE, P.L.C., 801 GRAND AVENUE, SUITE 3200, DES MOINES, IA, 50309-2721, US

(21) Appl. No.: 11/768,450

(22) Filed: Jun. 26, 2007

(51) Int. Cl. B01D 35/06; B01D 35/14

(52) U.S. Cl. 210/695; 210/87

(57) ABSTRACT

Improved detection and enumeration of magnetic particles in a flowing stream by enveloping the particle-containing sample stream with buffer streams from the sides and from the top, thus individualizing the particles and navigating the sample stream as a single-file flow into the proximity of sensors embedded underneath the flow channel. At the same time, larger physical size of the flow channel alleviates problems such as channel clogging. Magnetic particles can represent any analyte of interest, such as biomolecules or bacterial cells, which are labeled with magnetic labels.

### FIELD OF THE INVENTION

The present invention relates to detecting and enumeration of small magnetic particles flowing in a stream and to methods and instruments to enhance that detection.

### BACKGROUND OF THE INVENTION

This invention relates to an improvement over an earlier Porter et al. invention, U.S. Pat. No. 6,736,978 of May 18, 2004. The disclosure of that patent is incorporated herein by reference.

In recent years there has been an increasing interest in magnetic labels for chemical and bioanalysis, as exemplified by the interest in immunomagnetic separation technology, which is a proven method for such tasks as monitoring parasites in raw surface water. In some examples, the requirements of microorganism filtration, concentration, separation, and monitoring require bulky instrumentation and manual operation. Furthermore, magnetic tags can be used as separators for detection of molecules or cells of interest. One such example is described in Kriz; C. B.; Radevik, K; Kriz, D. “Magnetic Permeability Measurements in Bioanalysis and Biosensors,” Anal. Chem. 1996, 68, 1966, in which a ferromagnetic sample is placed in a container which in turn is placed in a measuring inductor electrically connected in a bridge sensing circuit.

In U.S. Pat. No. 6,736,978 there was provided a method of monitoring analyte flowing in fluid streams. A giant magnetoresistive sensor (GMR) had a plurality of sensing elements that produce electrical output signals; the signals vary dependent on changes in the magnetic field proximate the elements. A stream including the analyte was provided, and the stream had a magnetic property that was dependent on the concentration and distribution of analyte therein. The magnetic property was imparted by use of ferromagnetic particles or by use of paramagnetic or superparamagnetic particles in conjunction with application of a magnetic field. The stream flowed past the giant magnetoresistive (GMR) sensor in sufficiently close proximity to cause the magnetic properties of the stream to produce electrical output signals from the GMR. Electrical signals were then monitored as an indicator of the analyte concentration or distribution in the stream flowing past the GMR.

The apparatus for practicing that method included a giant magnetoresistive (GMR) sensor having a plurality of sensing elements for detecting localized changes in the magnetic field proximate the elements. Microfluidic channels were associated with the GMR sensor closely proximate the elements of the sensor. The proximity was such that the paramagnetic particles flowing in the channels caused an output from the GMR sensor that was indicative of the concentration or distribution of magnetic particles. A source of analyte in the fluid stream was altered such that the fluid stream had a magnetic property that was related to the concentration or distribution of the analyte in the stream. The fluid source was connected to the microfluidic channels for flowing a stream including the analyte past the GMR sensor. An electrical monitor was responsive to the GMR sensor for measuring and recording changes in the output signal as an indication of the magnetic properties and therefore analyte concentration or distribution in the stream flowing past the GMR sensor.

It has been determined that key to the success of the device and method described in the earlier Porter et al. patent is the efficiency of flow in the microfluidic channels and the efficient focusing of the flow stream close to the detector to improve detection. In particular in the present improvement on the prior patent the microfluidic layout of the device incorporates a novel three-dimensional fluidic focusing scheme that is easy to accomplish through two simple standard fabrication steps. This improvement in the device of the prior invention is the primary objective of the present invention.

In a more general sense, another primary objective is a magnetic particle detection arrangement that provides for better detection of passing magnetic particles in a liquid flow and entraining them to enhance detection capability while reducing the risk of microfluidic channel clogging.

Another objective is to develop a system useful with any microfabricated magnetic sensor, such as magnetic tunneling junctions or Hall sensors.

The method and means of accomplishing the above objectives and advantages of the invention will become apparent from the following detailed description when taken in conjunction with the accompanying drawings.

### BRIEF SUMMARY OF THE INVENTION

The method and device for enhanced detection of analyte in flowing fluid streams past a GMR sensor by utilizing a unique sample flow stream, preferably narrowed to a pinch flow configuration at one point and also confined towards the channel bottom by a vertical focusing stream that enters from the top of the sample flow and squeezed laterally as well by a lateral entry focus stream.

### BRIEF DESCRIPTION OF THE DRAWINGS

FIG. 1 is a conceptual drawing of how the three dimensional focusing scheme can be implemented by the geometry of microfluidic channels as used in the present invention.

FIG. 2 shows the fluidic layout to accomplish vertical flow focus and the lateral flow focus of the main channel particle stream of a microfluidic channel piece in order to enhance detection.

FIGS. 3a and 3b show compiled results from two dimensional numerical modeling of the flow focusing architectures for the lateral flow pinch and for the vertical confinement flow stream, both as illustrated in FIGS. 1 and 2.

FIG. 4 shows graphically how an initially uniform rectangular array of sample stream lines is refocused when passing through the microfluidic channels used in the present invention.

FIGS. 5a and 5b shows the GMR signals when the device is used in accordance with the example described for the present invention.

While the invention will be described in connection with certain preferred embodiments, there is no intent to limit it to those preferred embodiments. Rather the intent is to cover all alternatives, modifications and equivalents as included within the spirit and scope of the invention as defined by the appended claims.

### DETAILED DESCRIPTION OF THE PREFERRED EMBODIMENT

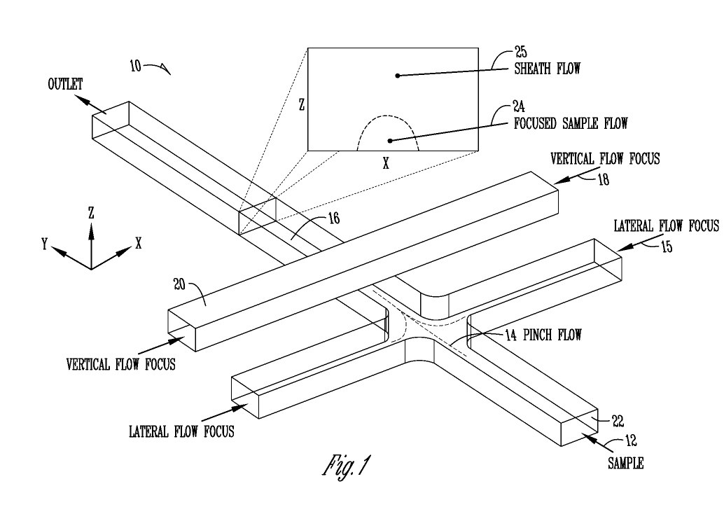

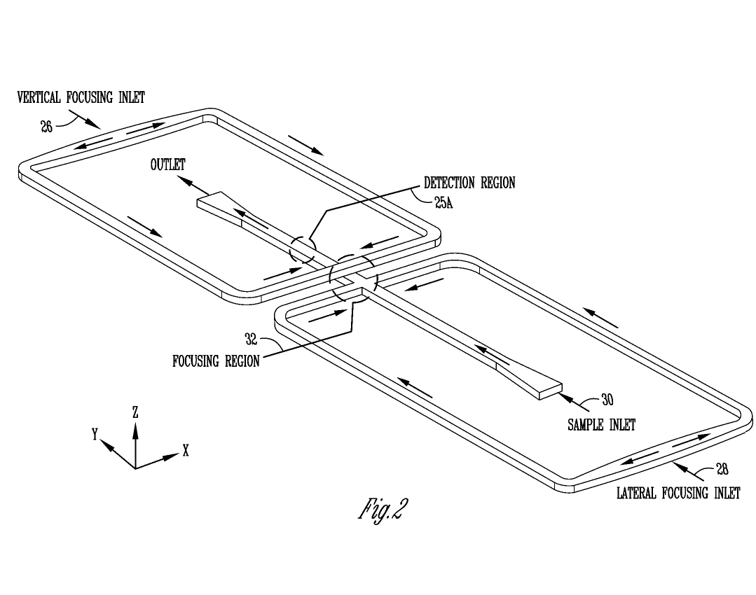

The general layout of a multiple element GMR flow cytometer is shown in FIGS. 1, 2 and for the state of the art in my prior patent. In the present unit and methodology therefore microfluidic channels of the prior unit are replaced with new ones. The microfluidic layout of the present device is illustrated in FIG. 1. The conceptual drawings of the three dimensional focusing scheme 10 is shown. The sample stream 12 is first narrowed in a “pinch flow” configuration 14 and then confined towards the channel bottom 16 by the combination of a vertical focusing stream 18 that enters from the top 20 of the sample flow channel 22. Stream lines 24 and sheath flow boundry 25 are shown to visualize the change of the sample stream boundaries.

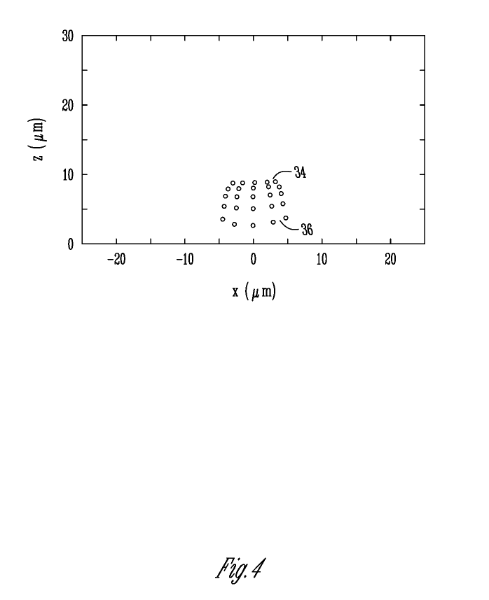

The concept of three dimensional focusing scheme as shown in FIG. 1 was developed as a result of recognition of two key issues identified in a recent report that critically examined the design and performance challenges in the development of a GMR flow cytometer. First, the sensor size (detection region 24 of FIG. 2) needs to be in the range of several micrometers to make single cell detection possible. Moreover, the proximity of the target to sensor is crucial, since observed field decays with the third power of distance. These requirements necessitate precise navigation of the sample stream over sensors. Simply pumping the sample through channels with small cross-sections can pose two problems: 1) clogging in the presence of particles with a distribution of sizes or particle aggregates, and 2) fabrication techniques become more challenging with downscaling the feature sizes. The inventors therefore chose to develop a detection format where micrometer-sized GMR sensors are buried beneath the channel of a relatively large cross-section. Upstream from sensors, the sample stream is hydrodynamically focused by a buffer flow from the sides 15 and from top 18 and 20 to form a narrow and thin flow stream 24 along the central bottom portion 16 of the channel (see FIG. 1). The sense elements in sensor bridges of the device (detector region 24) are centered along the projection of the sample stream after completing both focusing steps so that the main sample stream 12 is configured as in FIG. 4.

Since sample flow is confined and focused by surrounding and collapsing the sample stream with fluid rather then solid constrictions, this approach greatly reduces the risk of channel clogging. To ensure that target particles traverse precisely the sensor field of view, the flow rates from the two branches of the lateral-focus system need to be carefully balanced. Generally, the flow rates of the side-flow and vertical-flow buffer streams are chosen and controlled to ensure that the focused sample stream width, height, and the position in the main channel are optimal for a given size and geometry of the GMR sensors. Most times they are within 20% of each other and preferably within 10%. Those skilled in the art can readily make the necessary adjustments through trial and error experience.

A similar model for the case of imbalanced vertical focus flow rates (±10% deviation) shows only a slight drift of the sample stream from the middle of the channel (x=0). To achieve balanced flow rates and to reduce the number of fluidic connections to the chip, the lateral and the vertical focus feed from two external pumps are each split into two streams on-chip, immediately following the inlet ports. A careful design of the overall fluidic structure, including channel constrictions that serve as fluidic ballast resistors, ensures symmetrical backpressures and therefore symmetrical flows in the focusing branches. FIG. 4 gives an overview of two fluidic designs, and examples of two different sensor arrangements.

FIG. 2 demonstrates the fluidic layout corresponding to the schematics of FIG. 1 as occurs in the microfluidic channels associated with the GMR for providing the microfluidic channels closely proximate the sensor element 25a of the device described in our previous patent. In particular, the sample flow through the detection region 25a is oriented along the y-x axis and perpendicular to the applied field. The sample is sent through the vertical inlet 26 (depicted as an arrow). There is a lateral focusing inlet 28 (also depicted as an arrow) for enveloping the main particle sample fluid stream 30 from the side as well as the vertical sample inlet 26 for enveloping the main particle fluid stream 26 from the top. After being shaped and directed by the stream from the lateral focusing inlet 28 and the top or vertical focusing inlet 26, sample stream 30 is focused in region 32, then passes through the detection region 25.

The system utilizes spin-valve GMR sensors that are fabricated as 30-μm long, 2-μm wide strips, and they are sensitive to the transverse component of the magnetic field (x-axis direction). The electrically active area that generates the electrical signal is defined by the positioning of the electrical contacts on the sensor. The sensors are arranged in a Wheatstone bridge configuration. In the case of one sense resistor (Rₛ) and three reference resistors (Rᵣ), the measured signal is given by Equation 1:

$${E}_{1} - {E}_{2} = \frac{{R}_{s} - {R}_{r}}{2 ( {R}_{s} + {R}_{r} )} {E}_{bias} , \qquad ( 1 )$$

where E_{bias} is the constant bias voltage supplied to the bridge. In case of a pair of adjacent sense resistors, as in FIG. 2, assuming that the fringe field of the target is uniform across the overall sense resistor area, the measured signal will be twice as large as that obtained from Equation 1. The choice of the electrical layout and sensor size will depend on the size of the target, and will also dictate the choice of the fluidic layouts [FIG. 2] used to achieve the focused flow.

In our development work we studied how sample stream dimensions scale with the sample-to-focus flow rate ratios. In some cases, a simple linear approximation provides acceptable results. Hofmann et al. briefly discussed the experimentally observed non-linear scaling of sample thickness in vertical confinement flows, Hofmann, O., Niedermann, P. & Manz, A., “Modular approach to fabrication of three dimensional microchannel systems in PDMS-application to sheath flow microchips”, Lab on a Chip 1, 108-114 (2001). In the following discussion, we give a more thorough analysis that reveals important phenomena that somewhat contradict day-to-day linear intuition. The non-linear behavior is a consequence of the coupling of mass conservation requirements with the parabolic flow velocity profiles present in microchannels. The finite-element models were developed in FEMLAB based on fluidic layouts described above, and estimation of the experimental parameters—flow rates, target concentration range and the velocity distribution, and requisite sampling rates.

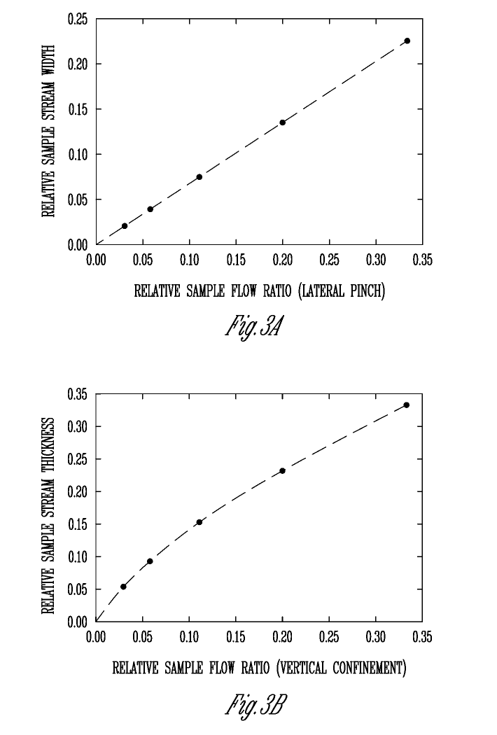

FIGS. 3a and 3b show results from two-dimensional models of the lateral and vertical focusing junctions. We define a relative flow rate as a ratio of the volumetric flow rate of the sample stream to the total volumetric flow rate. The models show that in case of the symmetrical “pinch-flow” focusing [FIG. 3(a)], the sample stream width follows a linear correlation with the relative sample flow rate, at least up to a relative flow ratio of 0.33. The sample-stream width, however, is narrower than that predicted by the simple rationing of flow rates, as the focus streams widen in order to compensate for their lower flow velocities in the parabolic flow profile. In case of the vertical confinement flow [FIG. 3 (b)], a non-linear dependence is readily apparent, and arises because the sample stream confined to the vicinity of the channel bottom compensates for the lower flow velocity by forming a thicker layer. This situation means that the actual sample-stream thickness will always be higher than that predicted by simple rationing.

These results can be used to estimate the relative flow rates required to achieve a given size of the sample stream. For example, in case of 2×10 μm sensors, with flow parallel to the field (x-axis direction), the sample stream width should be around 10 μm, i.e., a Δy of 0.2, relative to the channel width of 50 μm. This width value translates into the relative sample flow rate of around 0.3, or ωs/(ωs+ωl)=0.3, calling for the lateral focus flow rate of ωl=2.3 ωs. In a similar way, to achieve a thickness of at least 3 μm, or Δz=0.1 relative to the channel depth, the required vertical-focus flow rate is ωv=107 ωs, yielding a total flow rate of ω total=110 ωs. To understand the significance of the parabolic flow profiles in non-asymmetric flow focusing systems, it is useful to compare the above factor of 110 to the ratio of the channel cross-section to the focused stream cross-section, which equals 50 in this example.

Further analysis of three-dimensional models reveals another non-linear effect (FIG. 4)—a distortion of the sample streamlines upon focusing. The outcome is interesting and worth noting, since it suggests that an initially homogeneous suspension of target particles will tend to exhibit a slightly higher concentration in the top region of the focused sample stream.

That is to say an initially uniform rectangular array of the sample streamlines maps non-uniformly into a focused sample stream as illustrated in FIG. 4. The initial array upstream from the focusing junctions consisted of 5×6 streamlines and covered the sample inlet cross-section. Upon focusing, the streamline array is distorted as illustrated in FIG. 4, with the streamline density higher in the top 34 region than the bottom 36.

The following example is shown to demonstrate the efficiency of the unit in the detection of magnetotactic bacteria.

### EXAMPLE

### Detection of Magnetotactic Bacteria

Cells of marine magnetotactic vibrio MV-1 were cultured and then fixed overnight at 4° C. in 0.1% glutaraldehyde. The cells were washed three times, resuspended in Tris-borate buffer (pH 8.0), and subsequently stained by adding the Syto 16 fluorescent dye (1 mM solution in dimethylsulfoxide) to a final dye concentration of 2 μm. Fluorescent staining enabled determination of the cell counts using a hemocytometer and a microscope with a 40× objective lens, and the suspension was diluted with Tris-borate buffer to a final concentration of 30 000 cells/μL. The labeled cells appeared well dispersed, with no noticeable aggregates. Three syringe pumps were used to deliver the sample suspension and the two focusing streams (Tris buffer) to the chip. The device was based on the y-direction flow layout (perpendicular to the field), and featured bridges with a single sense and three reference 2×2 μm sensors. Only one of the four bridges was functioning properly. Applied bias voltage was E_{bias}=+0.2 V which required a current of 3.3 mA. The signal was digitized at 100 kHz after 50-fold amplification.

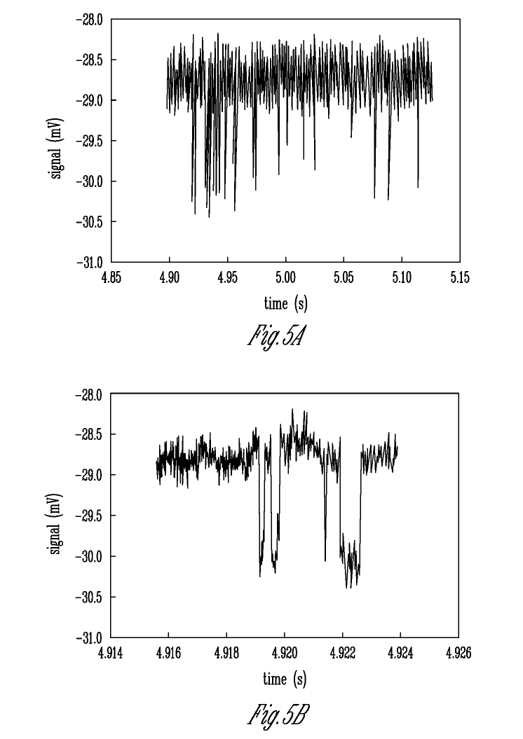

Because of the misalignment of the fluidic layer relative to sensors, a narrowly focused sample stream would miss the detection volume above the sensor. The flow rates were therefore chosen to produce a relatively wider sample stream that partly flows over the sense element. The flow rates were: sample flow rate ωs=0.023 μL/min, total lateral focus flow rate ωl=0.07 μL/min, and total vertical focus flow rate ωv=0.5 μL/min. These parameters yield a 9×9 μm cross-section of the sample stream. The collected GMR signal is shown in FIG. 5. When the lateral focus flow rate was increased to 0.13 μL/min to narrow down the sample stream to about 5 μm, the GMR signal collapsed to the baseline noise level. This was expected, since under those conditions the sample stream would flow just at the side of the detection volume.

FIGS. 5a and 5b show a snapshot of the GMR signal recorded during the flow of the magnetotactic bacteria, with 5b showing a detail of the same data set. External field strength equaled 1800 Am⁻¹ (22.6 Oe).

Preliminary experimental findings, based on magnetotactic bacteria as targets, apparently demonstrate single-cell detection events. Further work is needed to substantiate this and to fully exploit the potential of the system; this test however is sufficient to demonstrate that the focused flow stream cause by impinging the main particle stream from the top and the sides just prior to entering the detector focuses the flow stream close to the detector and improves detection significantly. Potential for clogging risk is further reduced and one can count the particles one at a time without them sticking to the walls.

It can therefore be seen that the use of the microfluidic chip or channel to direct the stream as illustrated herein accomplishes at least all of its stated objectives.

What is claimed is:

1. In the process of monitoring and detecting analyte flowing in fluid streams past a giant magnetoresistive (GMR) sensor, the improvement comprising:
enveloping the main particle sample fluid stream with buffer streams entering the main particle sample fluid stream both from the side and from the top of the main particle sample fluid stream.

2. The process of claim 1 wherein the side flow buffer stream enters the main particle fluid stream channel at a rate of flow within plus or minus 10% of the rate of flow of the main particle sample fluid stream.

3. The process of claim 1 wherein the side-flow buffer stream and vertical flow buffer stream enter the main particle sample fluid stream at the same rate of flow as the main particle sample fluid stream is traveling.

4. The method of monitoring analyte flowing in fluid streams comprising the steps of:
providing a GMR having at least one sensing element which produces electrical output signals that vary depending on changes in the magnetic field approximate the sensing element;
providing a fluid particle stream including the analyte, the fluid particle stream having a magnetic property dependent on the concentration and distribution of analyte therein;
providing a buffer stream that enters the fluid particle stream including the analyte from a lateral position and as well providing another buffer stream that enters the fluid particle stream including the analyte from a vertical position thereby enveloping and shaping the fluid particle stream;
flowing the shaped fluid particle stream past the giant magnetoresistive sensor in sufficiently close proximity to cause the magnetic properties of the fluid particle stream to produce electrical output signals from the giant magnetoresistive sensor; and
monitoring the electrical signals produced by the giant magnetoresistive sensor (GMR) as an indicator of at least one of an analyte concentration, an analyte distribution, and an analyte magnetic property in the fluid particle stream flowing past the giant magnetoresistive sensor (GMR).

5. The detecting system of claim 4 further comprising a magnetic field generator for controllably creating a magnetic field proximate to the at least one sensing element.

6. The detecting system of claim 5 wherein the giant magnetoresistive sensor comprises an array of sensing elements.

7. The process of claim 6 wherein the side flow buffer stream and the top flow buffer stream enter the main fluid particle stream channel at a rate of flow within plus or minus 10% of the rate of flow of the main sample fluid particle stream.

8. The process of claim 8 wherein the side flow buffer stream and the top flow buffer stream enter the main sample fluid particle stream at the same rate of flow as the rate of flow of the main sample stream.

9. A detecting system for monitoring the concentration of analyte present in a flowing fluid stream, the detecting system comprising in combination:
a giant magnetoresistive sensor (GMR) having at least one sensing element for detecting localized changes in a magnetic field proximate the sensing element;
microfluidic channels associated with the giant magnetoresistive sensor (GMR) for providing microfluidic channels closely proximate the sensor element, said channels including a main channel stream having a sample inlet and a sample outlet, a lateral channel focusing inlet for inletting of a lateral buffer stream into the main channel sample stream channel and a top inlet for letting a top buffer stream into the main channel stream of said microfluidic channel;
a pump for a fluid stream that has a magnetic property related to the concentration or distribution of analyte in the stream, the pump being connected to the microfluidic channels to allow for flowing a stream including the analyte past the giant magnetoresistive sensor; and
an electrical monitor responsive to the giant magnetoresistive sensor for measuring and recording changes in the output signal as an indication of the magnetic properties and therefore analyte concentration of distribution in the stream flowing past the giant magnetoresistive sensor.

10. The detection system of claim 9 wherein the microfluidic channels for the lateral focusing channel and the top-focusing channel are of the same dimensioned to maximize magnetic particle detection in a detection region of the microfluidic channels.
